(19) United States
(12) Patent Application Publication
(10) Pub. No.: US 2021/0354591 A1
(43) Pub. Date: Nov. 18, 2021

(54) CONTROL DEVICE FOR TEMPERATURE ADJUSTMENT DEVICE

(71) Applicant: Panasonic Intellectual Property Management Co., Ltd., Osaka (JP)

(72) Inventors: Takuma IIDA, Kanagawa (JP); Nobuaki SATOH, Kanagawa (JP); Koichi YAMAMOTO, Kanagawa (JP)

(21) Appl. No.: 17/286,800

(22) PCT Filed: Sep. 18, 2019
(86) PCT No.: PCT/JP2019/036567

§ 371 Date: Apr. 19, 2021

(30) Foreign Application Priority Data
Oct. 22, 2018 (JP) 2018-198360

(51) Int. Cl. B60L 58/24; B60L 53/68; B60L 53/66; G06Q 10/06; G05B 19/4155; H02J 7/00

(52) U.S. Cl. CPC B60L 58/24; B60L 53/68; B60L 53/66; G07C 5/008; G06Q 10/06313; G05B 19/4155; H02J 7/0071; G06Q 10/06312

(57) ABSTRACT

This control device (100) controls a temperature adjustment device (4) for adjusting the temperature of an on-board battery (1) and is provided with a control unit (104) for operating the temperature adjustment device so that the temperature of the on-board battery (1) falls within a predetermined range at a charging start point of charging the on-board battery (1) using an external charging facility (M).

### TECHNICAL FIELD

The present disclosure relates to a control apparatus that controls a temperature adjustment apparatus.

### BACKGROUND AN

In the related art, there is known a temperature adjustment apparatus (for example, a heater, a cooling apparatus or the like) which is mounted together with an on-board battery on a vehicle (for example, a hybrid vehicle or an electric vehicle), and which adjusts the temperature of the on-board battery.

For example, when an on-board battery is discharged or charged, a temperature adjustment apparatus of this type restrains a rise in the battery temperature, damage to the on-board battery, and/or a failure to acquire preferred charge and discharge characteristics.

### CITATION LIST

### Patent Literature

### PTL 1

### Japanese Patent Application Laid-Open No. 2016-025008

### SUMMARY OF INVENTION

### Technical Problem

Incidentally, in recent years, charging power supplied from an external charging facility (for example, a quick charging facility of a charging station) to an on-board battery (hereinafter, which may also be referred to simply as “battery”) tends to increase from a request for shortening a charging time, and a calorific value of a battery also tends to increase accordingly.

For this reason, a general cooling system mounted on a vehicle may not be sufficient for cooling of a battery and the temperature of the battery may abnormally increase. Such an increase in the temperature of a battery lowers a current value of an allowable current when the battery is charged, and causes a state in which there is no other choice but to lower charging power during charging, which as a result leads to a prolonged charging time.

Given such a background, for example, Patent Literature (hereinafter, referred to as “PTL”) 1 describes that a cooling mechanism is provided on a side of a charging station, and that when it is determined that a conveyance carriage such as an AGV is present in the charging station, a cooling start command is output from a side of a charger and a battery in the conveyance carriage is cooled. However, the related art of PTL 1 has a configuration in which the battery is cooled after the start of charging so that the cooling capacity of the battery may not be sufficient for a heat generation of the battery and the battery may not be charged in a preferred temperature range.

The present disclosure has been made in view of the problems described above and has an object to provide a control apparatus for a temperature adjustment apparatus capable of shortening a charging time when an on-board battery is charged using an external charging facility.

### Solution to Problem

A main aspect of the present disclosure for solving the above-mentioned problems is a control apparatus that controls a temperature adjustment apparatus that adjusts a temperature of an on-board battery. The control apparatus includes a controller that operates the temperature adjustment apparatus such that the temperature of the on-board battery falls within a predetermined range at a charging start point of charging the on-board battery by using an external charging facility.

### Advantageous Effects of Invention

The control apparatus according to the present disclosure that controls a temperature adjustment apparatus makes it possible to shorten a charging time when an on-board battery is charged by using an external charging facility.

### BRIEF DESCRIPTION OF DRAWINGS

FIG. 1 illustrates a configuration of a charging system according to an embodiment;

FIG. 2 illustrates an aspect of use of the charging system according to the embodiment;

FIG. 3 illustrates a database of a management server according to the embodiment;

FIG. 4 illustrates an entire configuration of a vehicle according to the embodiment;

FIG. 5 illustrates a hardware configuration of an ECU according to the embodiment;

FIG. 6 illustrates a functional block of the ECU according to the embodiment;

FIG. 7 illustrates an exemplary temperature characteristic of a battery during charging according to the embodiment;

FIG. 8 illustrates an exemplary temperature transition of the battery when a controller operates a cooling apparatus in accordance with an operation plan according to the embodiment; and

FIG. 9 is a flowchart illustrating an operation of the ECU according to the embodiment.

### DESCRIPTION OF EMBODIMENTS

Hereinafter, a preferred embodiment of the present disclosure will be described in detail with reference to the accompanying drawings. Note that, components having substantially the same functions are assigned the same reference numerals in the description and drawings to omit duplicated descriptions thereof.

[Configuration of Charging System]

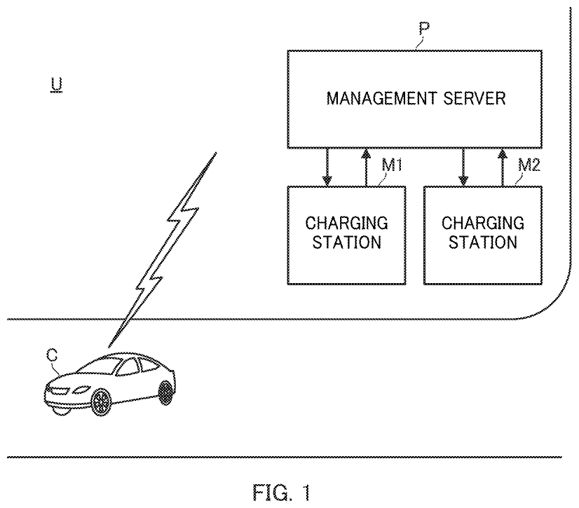

First, a configuration of charging system U according to an embodiment will be described with reference to FIGS. 1 to 3. Charging system U according to the present embodiment is a system that allows vehicle C to make a use reservation at charging station M1 or M2 in advance when battery 1 mounted on vehicle C is charged at the charging station.

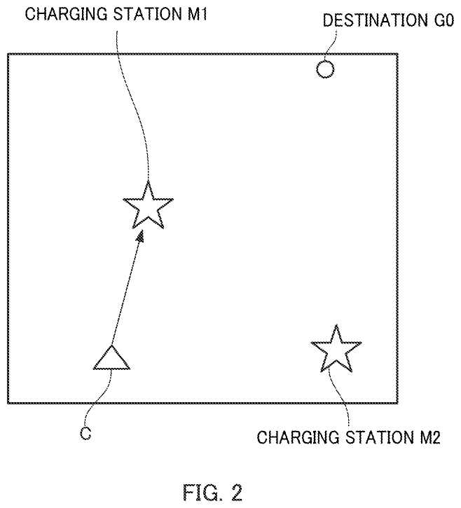

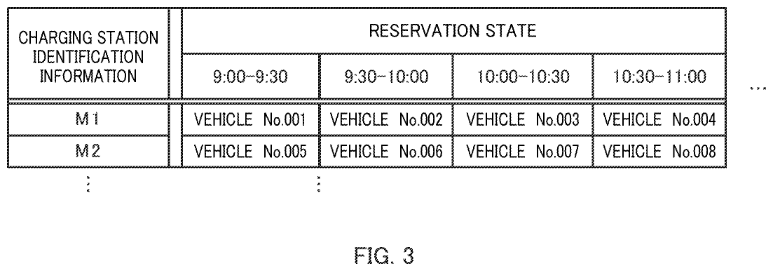

FIG. 1 illustrates a configuration of charging system U according to the present embodiment. FIG. 2 illustrates an aspect of use of charging system U according to the present embodiment. FIG. 3 illustrates a database of management server P according to the present embodiment.

Charging system U according to the present embodiment includes vehicle C, management server P, and charging stations M1 and M2 disposed on the road. Note that, FIG. 2 illustrates vehicle C and charge stations M1 and M2 on a map. Vehicle C travels toward destination GO. Charge stations M1 and M2 are disposed on the road.

Charging stations M1 and M2 each are external charging facility M that supplies DC power (for example, a quick charging facility that supplies 400V DC power), for example. Charging station M1 and charging station M2 are charging stations disposed in different locations, respectively, and have the same configuration. For example, when an own plug of charging station M1 or M2 is connected to a terminal provided in vehicle C, the charging station including the plug charges battery 1 of vehicle C via the plug. Note that, charging stations M1 and M2 are referred to hereinafter as “external charging facility M” in a case where no distinction is made therebetween.

Management server P, for example, manages use and reservation states of external charging facility M disposed on the road, and the like. Further, management server P is configured to be capable of performing communication with vehicle C (ECU 100 mounted on vehicle C, which will be described later) via a communication network (for example, an Internet line). In addition, management server P is configured to be capable of receiving a use reservation for external charging facility M from vehicle C through communication with vehicle C. Note that, the term “use reservation” means a reservation for temporarily occupying use of external charging facility M at external charging facility M.

Note that, management server P according to the present embodiment stores time zones of use reservations and identification information of vehicles C having made use reservations in a database for each of a plurality of external charging facilities M, for example (see FIG. 3).

An aspect of a use reservation in charging system U according to the present embodiment is not particularly limited, but charging system U functions as follows, for example. In a case where management server P receives a request for reservation state confirmation from vehicle C, management server P transmits e.g. a reservation state of charging stations M1 and M2, which are present near a current location of vehicle C, to vehicle C. Vehicle C then transmits a request for a use reservation, which includes information on one charging station of a plurality of charging stations M1 and M2 presented from management server P and on a time zone of a use reservation, to management server P. Management server P then receives the request for a use reservation from vehicle C, updates the reservation state in the database, and notifies the charging station, of which the request for a use reservation has been received, to this effect.

Note that, FIG. 2 illustrates a state in which charging station M1 is selected as a charging station for which a use reservation is made and vehicle C is traveling toward charging station M1.

[Configuration of Vehicle]

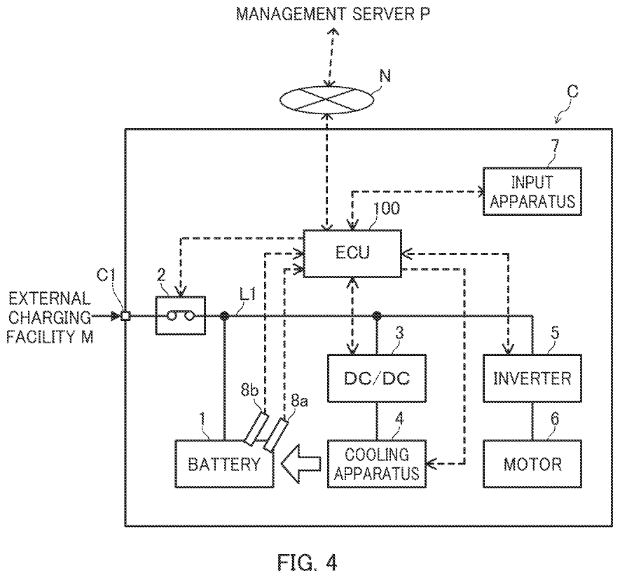

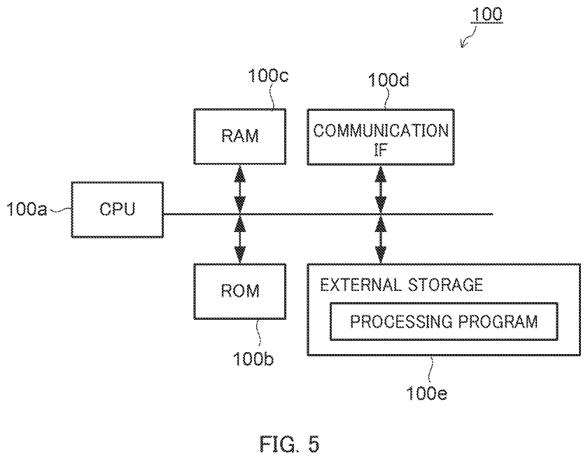

Next, an entire configuration of vehicle C according to the present embodiment will be described with reference to FIGS. 4 and 5.

FIG. 4 illustrates the entire configuration of vehicle C according to the present embodiment. FIG. 5 illustrates a hardware configuration of ECU 100 according to the present embodiment.

Vehicle C includes terminal C1, battery 1, switch 2, DC/DC converter 3, cooling apparatus 4, inverter 5, motor 6, input apparatus 7, a variety of sensors 8a and 8b, and electronic control unit (ECU) 100.

Terminal C1 is configured to be connectable to a plug of external charging facility M. Further, vehicle C receives power (here, DC power) from external charging facility M via terminal C1 and charges battery 1.

Power line L1 is connected to terminal C1. Power line L1 branches from a side of terminal C1 to battery 1, DC/DC converter 3, and inverter 5 such that battery 1, DC/DC converter 3, and inverter 5 are connected in parallel. Further, power received by terminal C1 from external charging facility M is supplied to battery 1, DC/DC converter 3 and the like via power line L1.

Battery 1 is a high-voltage battery serving as a power supply for an electric vehicle, and a 400V lithium-ion secondary battery is used, for example. Note that, the type of battery 1 is not particularly limited in the present invention, and a nickel hydrogen secondary battery, an electric double-layer capacitor or the like may be used.

Battery 1 is connected to power line L1 and is configured to be chargeable and dischargeable via power line L1. When battery 1 is charged, for example, switch 2 is turned on and DC power from external charging facility M is supplied to battery 1. Further, when battery 1 is discharged, for example, inverter 5 performs a switching operation so that DC power stored in battery 1 is converted into AC power and is supplied to motor 6.

Switch 2 is provided between terminal C1 and battery 1 in power line L1 and switches an electrical connection state between terminal C1 and battery 1. Switch 2 becomes the ON state so that DC power from external charging facility M can be supplied to battery 1. Note that, switching of switch 2 between the ON state and the OFF state is executed, for example, based on a control signal from ECU 100.

DC/DC converter 3 converts DC power of a high-voltage system into DC power of a low-voltage system. DC/DC converter 3 is connected to terminal C1 via power line L1, and converts DC power from external charging facility M into low-voltage DC power to supply the low-voltage DC power to cooling apparatus 4 and the like. Further, DC/DC converter 3 is connected to battery 1 via power line L1, and converts DC power from battery 1 into low-voltage DC power to supply the low-voltage DC power to cooling apparatus 4 and the like. Note that, DC/DC convener 3 operates in a desired operation mode by a control signal from ECU 100, for example.

Cooling apparatus 4 (corresponding to “temperature adjustment apparatus” of the present invention) cools battery 1. Cooling apparatus 4 is, for example, a water-cooled cooling apparatus, and includes a circulation circuit configured to circulate a cooling medium for exchanging heat with a heat sink provided in battery 1, a pump configured to adjust the circulation speed (that is, cooling capacity) of the cooling medium that is circulated in the circulation circuit, and a radiator configured to radiate heat from the cooling medium by exchanging heat with the cooling medium.

Note that, cooling apparatus 4 is configured such that the output of the pump (that is, the circulation speed of the cooling medium) is variable by a control signal from ECU 100, for example. Further, in cooling apparatus 4, the cooling capacity for cooling battery 1 is adjusted by a control signal from ECU 100.

Inverter 5 converts DC power received from battery 1 into AC power and supplies the AC power to motor 6. Further, in a case where motor 6 performs a regenerative operation, inverter 5 converts regenerative power sent from motor 6 into DC power and sends the DC power to battery 1 and the like.

Motor 6 receives AC power supplied from inverter 5 and generates a driving force for causing a vehicle to travel. As motor 6, a permanent magnet-type synchronization motor or a cage-type induction motor is used, for example.

Input apparatus 7 is, for example, a user interface such as a touch screen. Input apparatus 7 acquires operation information input by an operator (that is, an occupant of a vehicle) and transmits the operation information to ECU 100. Note that, input apparatus 7 executes processing of receiving a use reservation in accordance with a command from ECU 100 such that an operator can execute a use reservation for external charging facility M.

As the variety of sensors 8a and 8b, for example, charging rate sensor 8b configured to detect a charging rate of battery 1 from e.g. a cell voltage of battery 1, temperature sensor 8a configured to detect a temperature (for example, housing temperature) of battery 1 or the like are provided. Further, sensor signals detected by the variety of sensors 8a and 8b are transmitted to ECU 100. Note that, the variety of sensors 8a and 8b described above can be implemented by publicly known sensors, respectively.

ECU 100 is an electronic control unit that controls each part of vehicle C. ECU 100 is interconnected with each part, such as switch 2, DC/DC converter 3, cooling apparatus 4, inverter 5, input apparatus 7, and the variety of sensors 8a and 8b, via an on-board network, and exchanges required data and control signals with each part. Further, ECU 100 is communication-connected to management server P by communication line (for example, Internet line) N, and transmits and receives data to and from management server P via communication line N. Note that, the dotted lines in FIG. 4 indicate examples of signal paths.

ECU 100 includes, for example, central processing unit (CPU) 100a, read only memory (ROM) 100b, random access memory (RAM) 100c, communication IF 100d, external storage 100e, and the like. Further, ECU 100 performs operations as described later by CPU 100a referring to control programs or various kinds of data stored in ROM 100b and RAM 100c, for example. However, the aforementioned operations are implemented not only by processing using software, but also by a dedicated hardware circuit as a matter of course.

Note that, ECU 100 and controller 104 are not necessarily mounted on a vehicle. Cooling apparatus 4 may also be controlled from outside a vehicle by using a communication line or the like.

[Configuration of ECU]

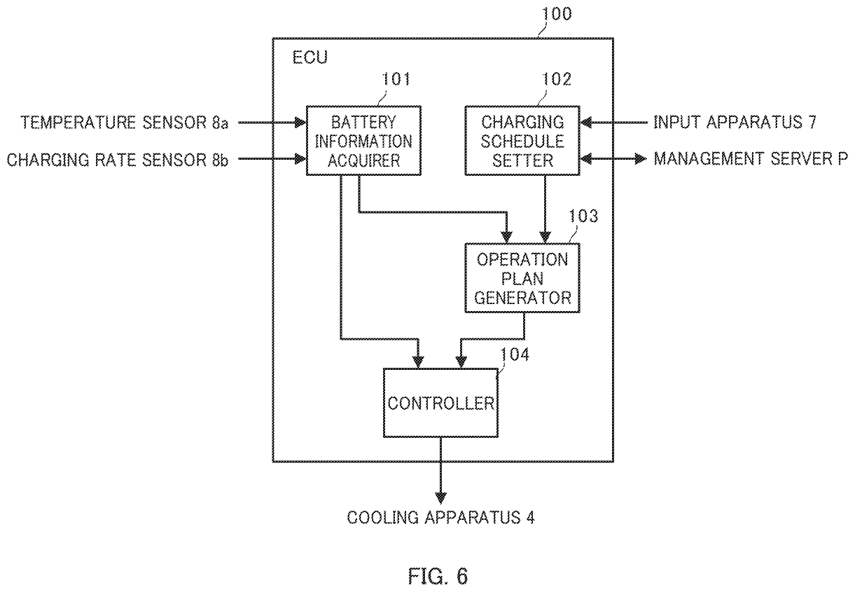

Next, a configuration of ECU 100 according to the present embodiment will be described with reference to FIGS. 6 to 8.

FIG. 6 illustrates a functional block of ECU 100 according to the present embodiment.

ECU 100 according to the present embodiment includes battery information acquirer 101, charging schedule setter 102, operation plan generator 103, and controller 104.

Battery information acquirer 101 acquires sensor signals from temperature sensor 8a configured to detect the temperature of battery 1 and charging rate sensor 8b configured to detect the charging rate of battery 1, respectively.

Charging schedule setter 102 sets a charging schedule in a storage (for example, RAM 100c) of ECU 100 in accordance with a predetermined command signal.

Charging schedule setter 102 functions, for example, so as to receive an operation of a use reservation for external charging facility 1\4 performed by an occupant of vehicle C, to perform communication with management server P, and to make a use reservation for external charging facility M. Further, charging schedule setter 102 sets charging schedule information when a use reservation for external charging facility M is made, for example.

“Charging schedule information” set by charging schedule setter 102 is information indicating that battery 1 is charged by using external charging facility M from a current point to a later point in time. “Charging schedule information” may be only a simple flag that does not define a time to start charging nor a location of a charging station, but more preferably is configured to include charging start time-related information (charging start time information) indicating a time to start charging of battery 1 by using external charging facility 1\4 or charging end time-related information (charging end time information) indicating a time to end charging of battery 1 by using external charging facility M.

Charging start time information set as “charging schedule information” is set, for example, in accordance with the contents of a use reservation for external charging facility M (for example, a charging start time in a time zone for which a use reservation is made is assumed as charging start time information). Further, with respect to charging end time information set as charging schedule information, a charging end time in a time zone for which a use reservation is made is assumed as charging end time information, for example. Note that, such a charging start time may also be information on a time when vehicle C arrives at external charging facility M, which is predicted based on road information, a current position of vehicle C, and a position of external charging facility M by using a navigation apparatus (not illustrated) mounted on vehicle C. Note that, charging schedule setter 102 may also set charging schedule information based on a setting other than a use reservation for external charging facility M. For example, in a case where a traveling route passing through external charging facility M is set in advance for automated driving or the like, charging schedule setter 102 may set charging schedule information when a traveling route is set.

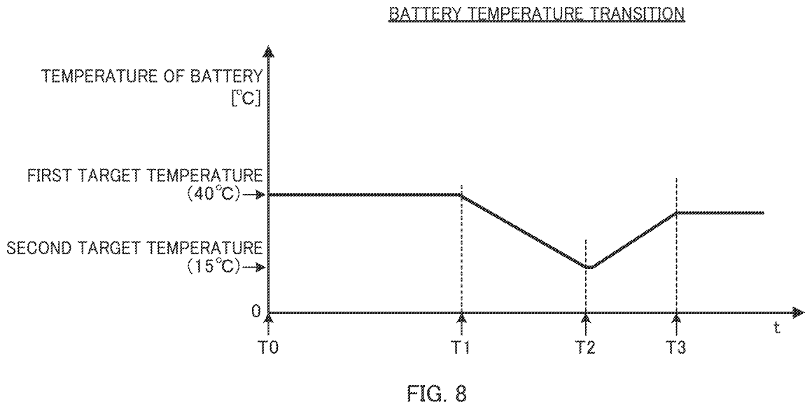

In a case where charging schedule information has been set, for example, operation plan generator 103 generates an operation plan for operating cooling apparatus 4 such that the temperature of battery 1 falls within a predetermined range at a point in time when battery 1 is electrically connected to external charging facility M (hereinafter, the point in time may also be referred to simply as “charging start point”). A generated operation plan is stored, for example, in the storage of ECU 100. Operation plan generator 103 generates an operation plan based on charging start time information or charging end time information. Typically, in order that the temperature of battery 1 at a charging start point becomes a target temperature suitable for charging, operation plan generator 103 generates an operation plan such that the temperature of battery 1 at a current point in time decreases (or increases) to the target temperature (see FIG. 8 described below).

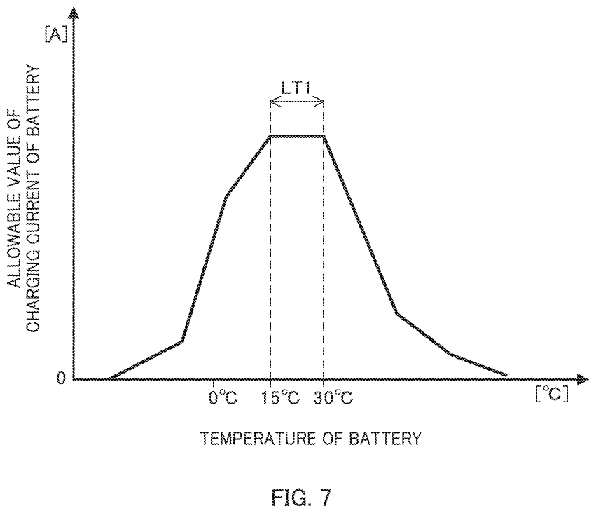

FIG. 7 illustrates an exemplary temperature characteristic of battery 1 during charging.

The temperature characteristic of battery 1 of FIG. 7 indicates an example of the relationship between the temperature of battery 1 and the allowable value of the charging current of battery 1 when the charging rate of battery 1 is the same (for example, 20%). The horizontal axis of FIG. 7 represents the temperature [° C.] of battery 1, and the vertical axis thereof represents the allowable value [A] of the charging current of battery 1.

In general, as illustrated in FIG. 7, the allowable value of the charging current of battery 1 becomes large when the temperature of battery 1 falls within a predetermined range (corresponding to a range of 15° C. to 30° C. in FIG. 7, which will be referred to hereinafter as “optimum temperature range LT1”), and becomes smaller, when the temperature of battery 1 is outside optimum temperature range LT1, as the temperature of battery 1 deviates from optimum temperature range LT1. That is, the charging current that can be supplied from external charging facility M to battery 1 becomes smaller as the temperature of battery 1 deviates from optimum temperature range LT1.

During discharging (that is, when vehicle C is traveling), on the other hand, the temperature of battery 1 is usually higher than optimum temperature range LT1 during charging. Note that, as reasons for the above, it is possible to mention that the allowable value of the discharging current of battery 1 is higher than optimum temperature range LT1 that energy loss associated with cooling battery 1 excessively is reduced, or the like.

In view of such a temperature characteristic of such battery 1, ECU 100 according to the present embodiment controls the temperature of battery 1 such that the temperature of battery 1 falls within optimum temperature range LT1 when charging is executed by using external charging facility M. Having said that, when charging is executed by using external charging facility M, it is difficult to lower the temperature of battery 1 due to a heat generation of battery 1 itself.

Accordingly, in a case where ECU 100 (operation plan generator 103) according to the present embodiment receives an instruction of a charging schedule from an occupant of vehicle C or the like, ECU 100 adjusts the temperature of battery 1 in advance such that the temperature of battery 1 falls within optimum temperature range LT1 at a time of starting charging. Note that, a target temperature of battery 1 at a time of starting charging is typically a predetermined temperature within optimum temperature range LT1, but may also be set to a temperature lower than optimum temperature range LT1 in view of a temperature rise during charging.

An “operation plan” set by operation plan generator 103 includes, for example, information on a target temperature of battery 1 to which the temperature of battery 1 is lowered by a time of starting charging, on an output of cooling apparatus 4, and on time information for increasing the output of cooling apparatus 4 (that is, a time for increasing the cooling capacity of cooling apparatus 4). From the viewpoint of restraining unnecessary energy consumption, an “operation plan” is typically set such that the temperature of battery 1 can be cooled to a target temperature, when a charging start time approaches (that is, when vehicle C approaches near external charging facility M), and at a time of starting charging.

Note that, operation plan generator 103 may set a target temperature of battery 1 at a charging start point in an “operation plan”. At this time, operation plan generator 103 generates an “operation plan” such that the temperature of battery 1 becomes the target temperature at the charging start point. Note that, a target temperature of battery 1 at a time of starting charging is desirably set based on charging rate information on battery 1, battery degradation information on battery 1, environmental information outside a vehicle or the like. Alternatively, a target temperature of battery 1 may also be set based on information obtained by combining the aforementioned pieces of information. Charging rate information on battery 1 affects a charging time when battery 1 is charged, and the lower the charging rate of battery 1, the higher the temperature of battery 1 during charging. Battery degradation information on battery 1 affects an internal resistance of battery 1, and the larger the internal resistance of battery 1, the higher the temperature of battery 1 during charging. Environmental information outside a vehicle (for example, air temperature) affects a heat dissipation characteristic when battery 1 is charged, and the higher the air temperature, the higher the temperature of battery 1 during charging, for example. Accordingly, in consideration of these elements, in a case where it is predicted that the temperature of battery 1 becomes high during charging, it is possible to shorten a charging time more efficiently by setting the target temperature low.

Further, an output of cooling apparatus 4 and time information for increasing the output of cooling apparatus 4 in an “operation plan” are desirably set based on charging rate information on battery 1. Thus, the charging rate of battery 1 is restrained from decreasing to zero [%] before arrival at external charging facility M. Note that, in an “operation plan”, for example, position information on vehicle C may be set instead of time information for increasing the output of cooling apparatus 4.

Controller 104 operates cooling apparatus 4 such that the temperature of battery 1 falls within a predetermined range. When battery 1 is discharged, controller 104 controls cooling apparatus 4 such that the temperature of battery 1 falls within a temperature range suitable for discharging (which may also be referred to hereinafter as “target temperature range during discharging”). Note that, a target temperature range during discharging is typically a temperature range on a higher temperature side than optimum temperature range LT1. When battery 1 is charged, on the other hand, controller 104 controls cooling apparatus 4 such that the temperature of battery 1 falls within a temperature range suitable for charging (optimum temperature range LT1 in FIG. 7).

In a case where an operation plan is generated by operation plan generator 103, however, controller 104 operates cooling apparatus 4 in accordance with the operation plan even when battery 1 is discharged.

FIG. 8 illustrates an exemplary temperature transition of battery 1 when controller 104 operates cooling apparatus 4 in accordance with an operation plan.

The vertical axis of FIG. 8 represents the temperature [° C.] of battery 1, and the horizontal axis represents the elapse of time from time T0 when the operation plan is set. In FIG. 8, T1 represents a time at which the cooling capacity of cooling apparatus 4 set in the operation plan is increased, T2 represents a time at which charging of battery 1 starts, and T3 represents a time at which the charging of battery 1 ends. Further, in FIG. 8, a first target temperature (for example, 40° C.) represents a target temperature when battery 1 is discharged, and a second target temperature (for example, 15° C.) represents a target temperature of battery 1 at a time of starting charging.

Between T0 and T1 of FIG. 8, controller 104 operates cooling apparatus 4 such that the temperature of battery 1 becomes the first target temperature (for example, 40° C.) that is the target temperature during discharging. Further, a time between T1 and T2 of FIG. 8 represents a state in which controller 104 operates cooling apparatus 4 at the maximum output such that the temperature of battery 1 decreases from the first target temperature to the second target temperature (for example, 15° C.). Further, a time between T2 and T3 of FIG. 8 represents a state in which controller 104 operates cooling apparatus 4 at the maximum output, but the temperature of battery 1 increases as charging of battery 1 starts.

In this manner, the temperature of battery 1 is lowered to within or below optimum temperature range LT1 at a time of starting charging. Further, lowering the temperature of battery 1 in advance at a time of starting charging makes it possible to perform charging of battery 1 in a state in which the allowable value of the charging current of battery 1 is high even when charging using a large power, such as quick charging, is performed.

[Operation Flow of ECU]

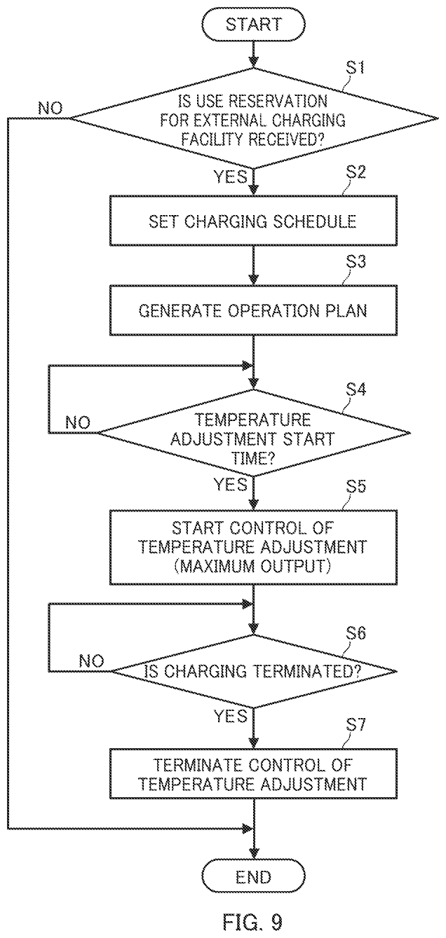

Hereinafter, an exemplary operation of ECU 100 according to the present embodiment will be described with reference to FIG. 9.

FIG. 9 is a flowchart illustrating an operation of ECU 100 according to the present embodiment. The flowchart illustrated in FIG. 9 represents, for example, an operation executed by ECU 100 in accordance with a computer program. Note that, FIG. 9 only illustrates processing related to control of temperature adjustment of battery 1.

In step S1, ECU 100 (charging schedule setter 102) determines whether a use reservation for external charging facility M is received. At this time, in a case where a use reservation is received (S1: YES), ECU 100 advances the processing to step S2. In a case where a use reservation is not received (S1: NO), on the other hand, ECU 100 terminates the operation flow of FIG. 9 without executing any particular processing.

In step S2, ECU 100 (charging schedule setter 102) performs communication with management server P to request a use reservation for external charging facility M, and sets a charging schedule in the storage of ECU 100 in accordance with the content of the use reservation for external charging facility M.

In step S3, ECU 100 (operation plan generator 103) sets an operation plan of cooling apparatus 4 in the storage of ECU 100 in accordance with the content of the charging schedule (that is, the content of the use reservation for external charging facility M). At this time, as an operation plan, ECU 100 sets information on timing for increasing the output of cooling apparatus 4, and a target temperature of battery 1 such that the temperature of battery 1 falls within optimum temperature range LT1 at a charging start point of charging battery 1, for example.

In step S4, ECU 100 waits for a temperature adjustment start time to be reached (S4: NO). In a case where the temperature adjustment start time is reached (S4: YES), ECU 100 advances the processing to step S5.

Note that, before the temperature control start time is reached, ECU 100 performs feedback control of cooling apparatus 4 in a state in which the target temperature of battery 1 is set to a target temperature during discharging (T0 to T1 in FIG. 8).

In step S5, ECU 100 maximizes the output of cooling apparatus 4 in order to start control of temperature adjustment (T1 to T2 in FIG. 8). Thus, when vehicle C arrives at external charging facility M, the temperature of battery 1 is lowered to the target temperature of battery 1 to which the temperature of battery 1 is to be lowered by start of charging.

Note that, even when battery 1 is charged, ECU 100 continues to cool battery 1 in a state in which the output of cooling apparatus 4 is maximized such that the temperature of battery 1 falls within optimum temperature range LT1.

In step S6, ECU 100 waits for the charging of battery 1 to be terminated (S6: NO). In a case where the charging of battery 1 is terminated (S6: YES), ECU 100 advances the processing to step S7 (T3 in FIG. 8).

In step S7, ECU 100 returns the operation of cooling apparatus 4 to a steady state, and terminates the control of temperature adjustment. At this time, ECU 100 sets the target temperature of battery 1 to the target temperature during discharging again, thereby returning to control to operate cooling apparatus 4.

By performing processing as described above, ECU 100 according to the present embodiment is capable of lowering the temperature of battery 1 by the start of the charging of battery 1, and is capable of executing the charging of battery 1 at a current level around the allowable value of the charging current of battery 1.

### EFFECTS

As described above, ECU (control apparatus) 100 according to the present embodiment includes charging schedule setter 102 that sets a charging schedule in the storage of the control apparatus in accordance with a predetermined command signal (for example, a use reservation at an external charging facility), and controller 104 that operates cooling apparatus (temperature adjustment apparatus) 4 such that the temperature of battery 1 falls within a predetermined range at a charging start point in a case where a charging schedule is set.

Accordingly, cooling apparatus 4 according to the present embodiment makes it possible to adjust the temperature of battery 1 (typically, to lower the temperature of battery 1) such that the temperature of battery 1 falls within a temperature range in which a large allowable value of the charging current of battery 1 can be ensured, before executing charging at external charging facility M. Thus, when executing charging at external charging facility M, it is possible to execute charging of battery 1 with a charging current of a relatively large current level and to shorten a charging time.

Further, ECU 100 according to the present embodiment sets an operation plan of cooling apparatus 4 based on charging start time information set as a charging schedule, and operates cooling apparatus 4 based on the operation plan.

Thus, it is possible to restrain generation of unnecessary power consumption associated with cooling of battery 1 from a time earlier than necessary. That is, it is possible to achieve both energy saving and shortening of a charging time thereby.

### Other Embodiments

The present invention is not limited to the embodiment described above, and various modifications can be considered.

In the embodiment described above, as an example of charging schedule setter 102 of ECU 100, an aspect has been indicated in which charging schedule setter 102 sets a “charging schedule” when an occupant of vehicle C has set a use reservation for external charging facility M. However, it is arbitrary when charging schedule setter 102 sets a charging schedule, and charging schedule setter 102 may set a charging schedule when a destination of vehicle C is set to a charging station, for example. Further, charging schedule setter 102 may also have an aspect in which ECU 100 of vehicle C automatically sets a charging schedule based on the charging rate of battery 1 or the like.

Further, in the embodiment described above, as an example of operation plan generator 103 of ECU 100, an aspect has been indicated in which operation plan generator 103 sets information on a target temperature of battery 1 to which the temperature of battery 1 is to be lowered by start of charging, on an output of cooling apparatus 4, and on a time for increasing the output of cooling apparatus 4 as an “operation plan” in the storage of ECU 100. However, operation plan generator 103 may also set only part of these pieces of information as an “operation plan”. For example, operation plan generator 103 may set only a time for increasing an operation capacity of cooling apparatus 4 as an “operation plan”.

Further, in the embodiment described above, as an example of controller 104 of ECU 100, an aspect has been indicated in which controller 104 operates cooling apparatus 4 in accordance with an operation plan. However, controller 104 may immediately start temperature adjustment of the battery when a charge schedule is set in the storage of ECU 100, such that the temperature of battery 1 falls within optimum temperature range LT1.

Further, in the embodiment described above, as an exemplary configuration of ECU 100, an aspect has been indicated in which each function of battery information acquirer 101, charging schedule setter 102, operation plan generator 103, and controller 104 is implemented by one computer, but part or all of each function may be implemented by being distributed to a plurality of computers as a matter of course. For example, some of the functions of ECU 100 may be distributed on management server P.

Further, in the embodiment described above, a quick charging facility that charges battery 1 by using DC power has been indicated as an example of external charging facility M. However, external charging facility M may be a charging facility that charges battery 1 by using single-phase AC power or three-phase AC power. Further, when power is supplied from external charging facility M to battery 1, a non-contact power supply may be used.

Further, in the embodiment described above, a water-cooled cooling apparatus has been indicated as an example of temperature adjustment apparatus 4 that adjusts the temperature of battery 1. However, ECU 100 of the present invention is applicable not only to a water-cooled cooling apparatus, but also to an air-cooled cooling apparatus using a cooling fan or the like, and further to a heater.

Note that, controller 104 may also operate cooling apparatus (temperature adjustment apparatus) 4 with power obtained by eliminating power, which is required for traveling from a current position to external charging facility M, from a charged amount (remaining amount) of battery 1, for example. At this time, in a case where an operating power of cooling apparatus (temperature adjustment apparatus) 4 for causing the temperature of battery 1 to become a target temperature is not sufficient, controller 104 may ensure the operating power of cooling apparatus (temperature adjustment apparatus) 4 by restraining or stopping operation of a load (for example, audio system, air conditioner or the like) that does not affect traveling. Alternatively, controller 104 may ensure the operating power of cooling apparatus (temperature adjustment apparatus) 4 by setting a path for which power consumption is low (for example, a path on which slopes and congestion are avoided) as a path to external charging facility M, performing control to restrain rapid acceleration and deceleration during traveling, or the like. Further, in a case where a temperature difference between an expected temperature of battery 1 in an operation plan and an actual battery temperature of battery 1 is equal to or larger than a predetermined value while controller 104 operates cooling apparatus 4 based on the operation plan, controller 104 preferably performs feedback control as appropriate, such as causing operation plan generator 103 to re-plan a temperature adjustment plan.

Specific examples of the present invention have been described in detail thus far, which are, however, merely examples and do not limit the scope of the claims. The techniques recited in the claims encompass various modifications and alterations of the specific examples exemplified hereinabove.

The disclosure of Japanese Patent Application No. 2018-198360, filed on Oct. 22, 2018, including the specification, drawings and abstract, is incorporated herein by reference in its entirety.

### INDUSTRIAL APPLICABILITY

The control apparatus for the temperature adjustment apparatus according to the present disclosure is capable of shortening a charging time.

### REFERENCE SIGNS LIST

U Charging system
M External charging facility
P Management server
C Vehicle
C1 Terminal
1 Battery
2 Switch
3 DC/DC converter
4 Cooling apparatus (temperature adjustment apparatus)
5 Inverter
6 Motor
7 Input apparatus
8a Temperature sensor
8b Charging rate sensor
100 ECU (control apparatus)
101 Battery information acquirer
102 Charging schedule setter
103 Operation plan generator
104 Controller

1. A control apparatus that controls a temperature adjustment apparatus that adjusts a temperature of an on-board battery, the control apparatus comprising
a controller that operates the temperature adjustment apparatus such that the temperature of the on-board battery falls within a predetermined range at a charging start point of charging the on-board battery by using an external charging facility.

2. The control apparatus according to claim 1, further comprising a charging schedule setter that sets charging schedule information for charging the on-board battery by using the external charging facility, wherein
in a case where the charging schedule information is set by the charging schedule setter, the temperature adjustment apparatus is operated.

3. The control apparatus according to claim 2, wherein
the charging schedule setter sets the charging schedule information when a use reservation for the external charging facility is made.

4. The control apparatus according to claim 2, wherein
in a case where the charging schedule information is not set when the on-board battery is discharged, the controller operates the temperature adjustment apparatus such that the temperature of the on-board battery falls within a target temperature range during discharging higher than the predetermined range.

5. The control apparatus according to claim 4, wherein
the charging schedule information includes charging start time information for charging the on-board battery by using the external charging facility.

6. The control apparatus according to claim 5, further comprising an operation plan generator that generates an operation plan of the temperature adjustment apparatus based on the charging start time information, wherein
the controller operates the temperature adjustment apparatus based on the operation plan.

7. The control apparatus according to claim 4, wherein
the charging schedule information includes charging end time information for charging the on-board battery by using the external charging facility.

8. The control apparatus according to claim 7, further comprising an operation plan generator that generates an operation plan of the temperature adjustment apparatus based on the charging end time information, wherein
the controller operates the temperature adjustment apparatus based on the operation plan.

9. The control apparatus according to claim 6, wherein
the operation plan includes time information for increasing an operation capacity of the temperature adjustment apparatus.

10. The control apparatus according to claim 6, wherein
the operation plan generator generates the operation plan based on a charging rate of the on-board battery.

11. The control apparatus according to claim 10, wherein
the operation plan generator generates the operation plan based on battery degradation information on the on-board battery or environmental information outside the on-board battery.

12. The control apparatus according to claim 6, wherein
the operation plan generator sets a target temperature of the on-board battery at the charging start point, and generates the operation plan such that the temperature of the on-board battery becomes the target temperature at the charging start point.

13. The control apparatus according to claim 1, wherein
the controller is mounted on a vehicle.

14. The control apparatus according to claim 1, wherein
the external charging facility is a quick charging facility that charges the on-board battery by using DC power.

15. The control apparatus according to claim 1, wherein
power is discharged from the on-board battery, the power being for traveling of a vehicle on which the on-board battery is mounted, and
the predetermined range is different from a target temperature range during discharging when the on-board battery is discharged.

16. The control apparatus according to claim 15, wherein
in a case where the on-board battery is discharged, the controller operates the temperature adjustment apparatus such that the temperature of the on-board battery at the charging start point falls within the predetermined range.
